(19) United States
(12) Patent Application Publication
(10) Pub. No.: US 2008/0253455 A1
(43) Pub. Date: Oct. 16, 2008

(54) High Frame Motion Compensated Color Sequencing System and Method

(75) Inventors: Cornelis Conradus Adrianus Maria Van Zon, Cold Spring, NY (US); Lilla Boroczky, Mount Kisco, NY (US); Sandeep M. Dalal, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,512

(22) PCT Filed: May 3, 2005
(86) PCT No.: PCT/IB05/51445

§ 371 Date: Oct. 31, 2006

Related U.S. Application Data
(60) Provisional application No. 60/568,599, filed on May 6, 2004.
(60) Provisional application No. 60/591,404, filed on Jul. 27, 2004.

(51) Int. Cl. H04B 1/66

(52) U.S. Cl. 375/240.16; 375/E07.123

(57) ABSTRACT

A system and method for generating high frame rate motion compensated color sequencing data for a color sequential display system. A high frame rate motion compensation color sequencing system (10) is provided, comprising: a system for receiving a first input frame and a second input frame, and for receiving motion vectors (18) associated with the input frames (16); and an interpolation system (12) that processes the motion vectors and input frames and generates high frame rate motion compensated color sequence data (20) with an output frame rate defined by an upconversion factor (26).

The present invention relates generally to color sequential display systems, and relates more particularly to a system and method for generating high frame rate motion compensated color sequencing data for such a system.

Color image displays are of two general types. In a first type, exemplified by a typical direct view cathode ray tube color display, all color image components are displayed simultaneously. Thus, an image model, e.g., a CCIR-601 signal, defines the luminance and chrominance of each image pixel at a particular time. The motion image is therefore presented as a time sequence of color image frames.

In a second type of color image display, color image planes are displayed sequentially. Color sequential displays display the Red, Green, Blue (RGB) colors alternating during a frame period. This type of system is employed, for example, in certain single panel image projection systems, in which light of various colors sequentially illuminates a common spatial light modulator. The spatial image modulator, therefore, modulates the intensity of each respective color component of a pixel sequentially and independently, which is perceived as a color motion image.

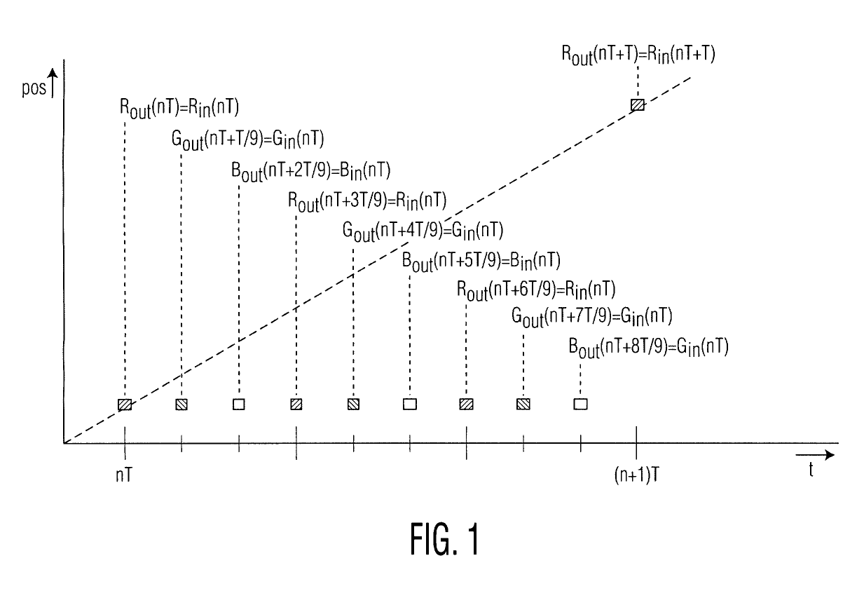

One type of artifact, referred to as “color break-up” or the “color flash effect” (CFE), occurs in color sequential projectors when the different colors for an object image are received onto different portions of the retina. The visual result is that there can be red, green and blue fringes at the edges of high-contrast boundaries. There are two sources for this effect: (1) motion of an object within an image; and (2) motion of the viewer's eye. It is known that the visibility of color breakup decreases when the display frame rate increases. Therefore, displays such as LCoS, commercialized as CINEOS™, use a display frame rate of 180 Hz, which is achieved by repeating each incoming frame three times. An example of this display scheme is illustrated in FIG. 1 for RGB input and output. For this example, the display frame rate is 3× the input frame rate (i.e., each color R, G and B is shown three times during each input frame interval T), while the display color field rate is 9× the input frame rate (i.e., there are nine display intervals during each input frame interval T).

While the above-mentioned high frame rate technique is useful for addressing color breakup, it does not completely eliminate the problem. Accordingly, a need exists for a system and method that further reduce artifacts and motion judder introduced by sequential color displays.

The present invention addresses the above-mentioned problems, as well as others by providing a system, method and display for generating high frame rate motion compensated color sequencing data for a color sequential display. In a first aspect, the invention provides a high frame rate motion compensation color sequencing system, comprising: a system for receiving a first input frame and a second input frame, and for receiving motion vectors associated with the input frames; and an interpolation system that processes the motion vectors and input frames and generates high frame rate motion compensated color sequence data with an output frame rate defined by an upconversion factor having a value greater than one.

In a second aspect, the invention provides a method for generating high frame rate motion compensated color sequencing data, comprising: receiving a first input frame, a second input frame, and motion vectors associated with the input frames; and interpolating the first and second input frames using the motion vectors to generate high frame rate motion compensated color sequence data during a defined output time period, wherein a frame rate for the defined output time period is dictated by an upconversion factor.

In a third aspect, the invention provides a color sequential display having a system for generating high frame rate motion compensated color sequencing data, comprising: means for calculating motion phases based on an upconversion factor to determine temporal locations for outputted color sequence data; means for receiving a first input frame, a second input frame, and motion vectors associated with the input frames; and means for positionally interpolating the first and second input frames at the calculated motion phases using the motion vectors.

These and other features of this invention will be more readily understood from the following detailed description of the various aspects of the invention taken in conjunction with the accompanying drawings in which:

FIG. 1 depicts an output graph of color data that has been upconverted to a higher frame rate by means of frame repetition.

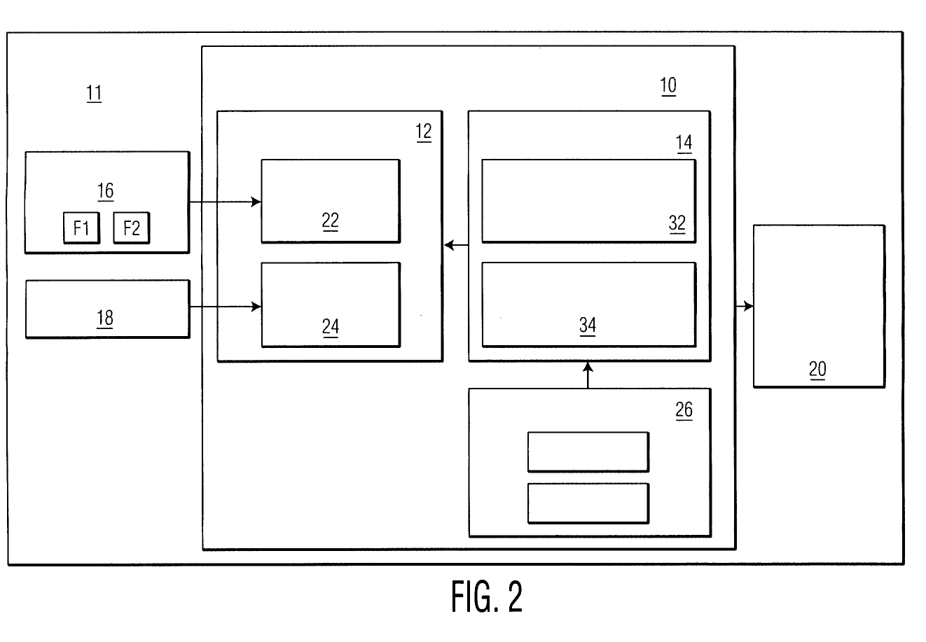

FIG. 2 depicts a color sequential displays system that includes a high frame rate motion compensated color sequencing system in accordance with the present invention.

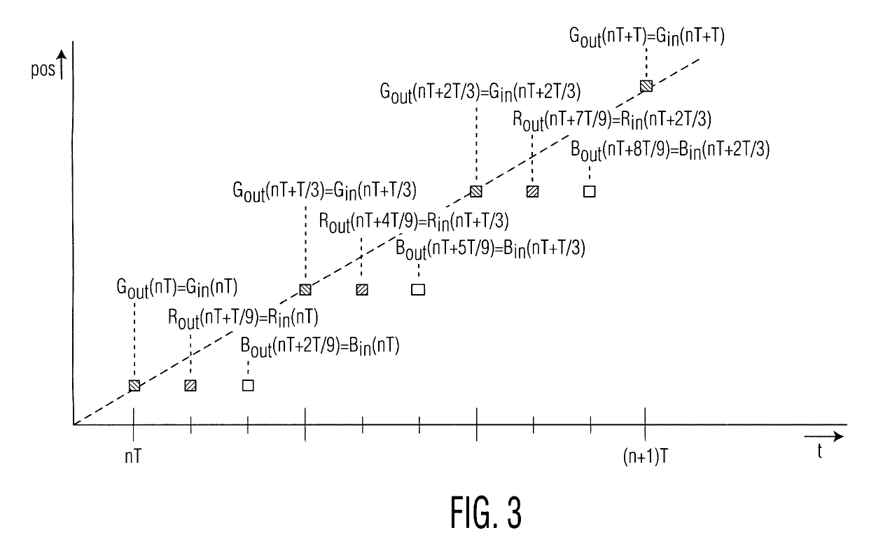

FIG. 3 depicts an output graph of upconverted color data in which each frame has been motion compensated in accordance with the present invention.

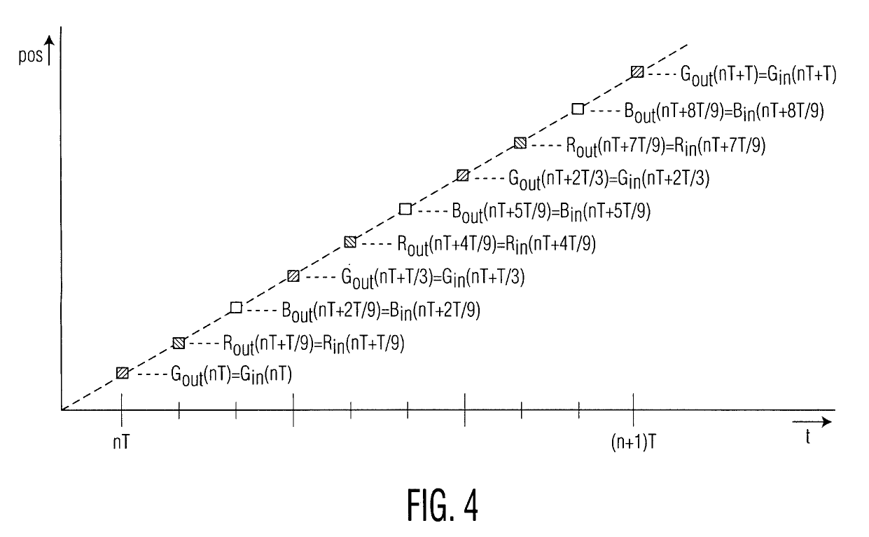

FIG. 4 depicts an output graph of upconverted color data in which each color field has been motion compensated in accordance with the present invention.

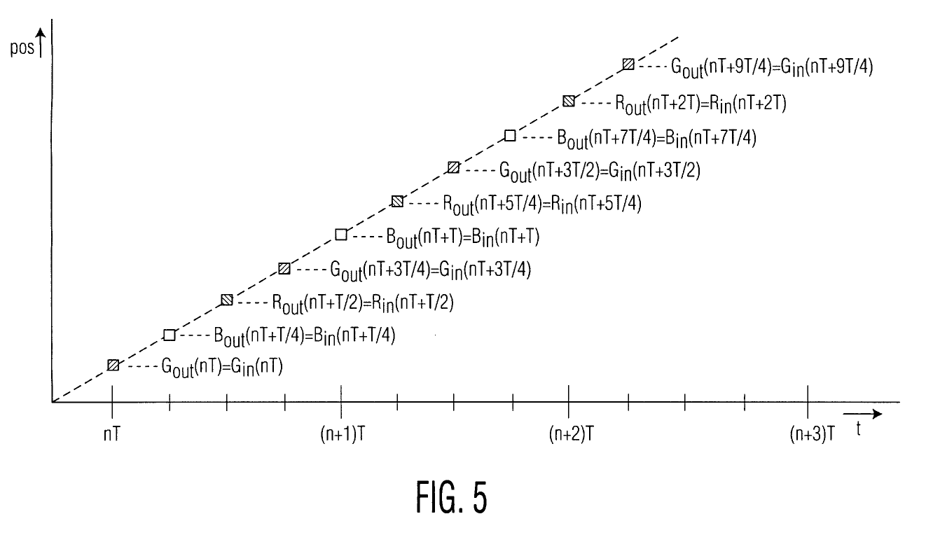

FIG. 5 depicts an output graph of high frame rate motion compensated data having a non-integer upconversion factor in accordance with the present invention.

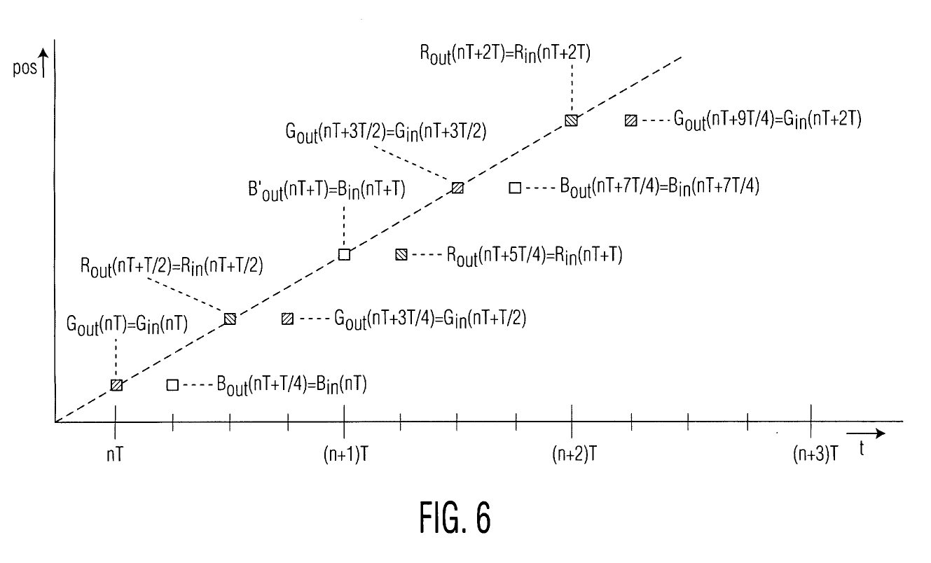

FIG. 6 depicts an output graph of high frame rate motion compensated data having a non-integer upconversion factor having reduced motion phase calculations in accordance with the present invention.

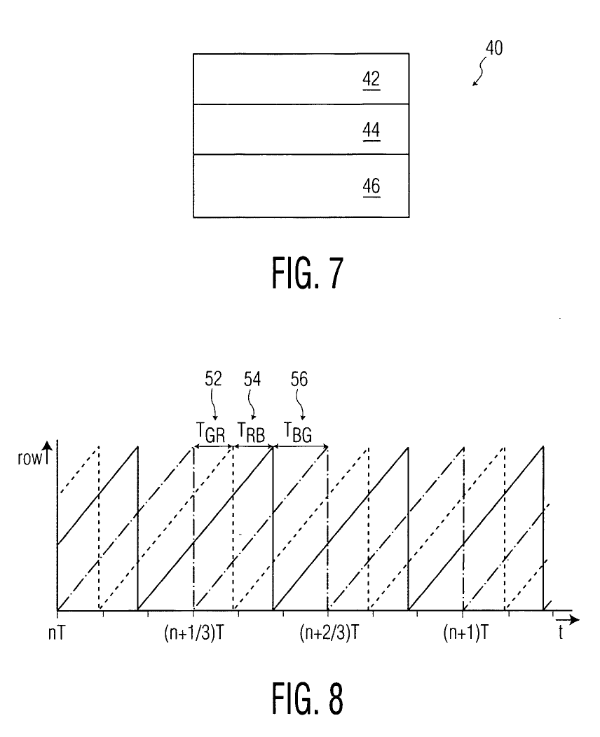

FIG. 7 depicts a display panel displaying three colors.

FIG. 8 depicts the panel drive scheme for the display panel of FIG. 7.

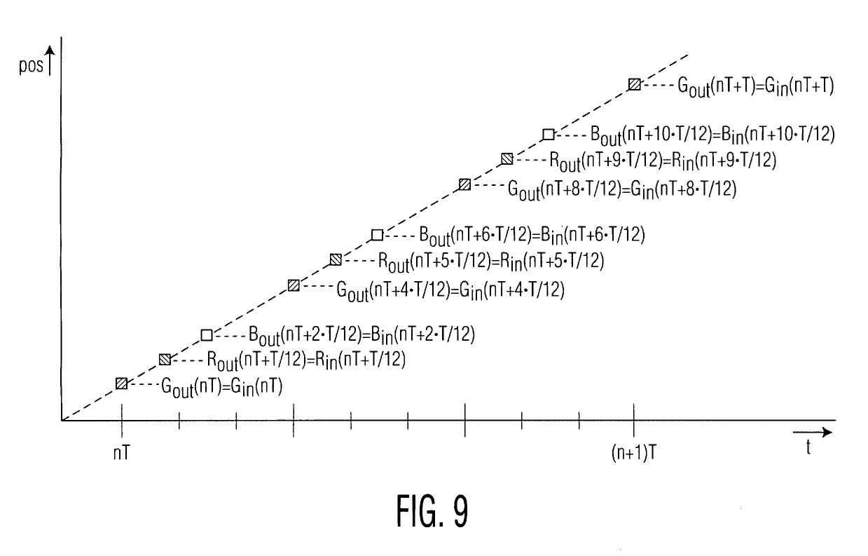

FIG. 9 depicts an output graph in which non-uniform time spacing has been applied in accordance with the present invention.

As noted above, high frame rate color sequential display systems, such as CINEOS™, repeat the input frame data in the output (as shown in FIG. 1) to improve picture quality. The present invention further improves the effectiveness of high frame rate color sequential display systems by utilizing motion compensation techniques. The result, referred to herein as “high frame rate motion compensated color sequencing,” is beneficial for reducing motion judder, and reducing color breakup.

FIG. 2 depicts an illustrative high frame rate motion compensated color sequencing system 10 that includes an interpolation system 12 for upconverting input frame data 16 aided by motion vectors 18 to generate high frame rate motion compensated color sequential data 20 (“output data 20”). Interpolation is accomplished by examining two input frames (e.g., F1 and F2) and the motion vectors that specify object motion between these frames, and calculating new frames at temporal locations between the two original input frames. Thus, for each input frame, a set of output frames will be created to be displayed during a defined time period equal to an input frame period T divided by an upconversion factor 26. The number of newly created output frames is dictated by the upconversion factor 26 that is provided to motion phase calculation system 14.

At least one of the input frames can be stored in memory (e.g., RAM) to allow the above interpolation process to be implemented. In some applications, it may be desirable to interpolate between more than two input frames when creating new output frames. In these instances, as many frames as is necessary can be stored in memory.

Interpolation system 12 may be implemented using any known interpolation technique that takes into account frame data 16 from two contiguous frames, and their respective motion vectors 18. For instance, a pixel at a location pix_{n+Δ}(x) at a spatial location x=(x,y)^{T} can be interpolated at a temporal location A between two frames at n−1 and n, using the equation:

pix_{n+Δ}(x)=½·bilinₙ₋₁(x−(pix_{n+Δ}(x)+1)vₙ)+½·bilinₙ(x−Δvₙ),

where

Δ=−1 at n−1, and Δ=0 at n. For an upconversion factor of 3, two new frames need to be calculated, one at Δ=−⅓ and one at Δ=−⅔. Data is taken from the input frames by means of bilinear interpolation (bilin), which is needed because the motion vector vₙ will in general not have integer components. PCT Publication WO 01/10131 A1, A System and Method for Motion Compensation of Image Planes in Color Sequential Displays, published on Feb. 8, 2001, which is hereby incorporated by reference, also describes related techniques.

High frame rate motion compensated color sequencing system 10 may be implemented in any fashion, including as a standalone system, a program product, integrated into a complete color sequential display system 11 that includes, e.g., color space conversion, motion estimation, a color sequential display panel, etc. Input frame data 16 may exist in any color space (e.g., RGB, YUV, etc.), and output data 20 will generally comprise color primaries such as RGB. In addition, input frame data 16 and motion vectors 18 can be derived from any source, e.g., from other components in color sequential display system 11 such as color space conversion, motion estimation, etc. Output data 20, which will ultimately by displayed by a color sequential display panel (not shown), may likewise be further processed within color sequential display system 11, e.g., by color space conversion, etc.

Note that high frame rate motion compensated color sequencing system 10 depicts components that provide several (mutually exclusive) implementation possibilities. It should therefore be understood that not all of the components described therein need to be included for each implementation, i.e., the necessary components will be based on the particular implementation required by the designer. Moreover, it should be understood that the arrangement of the components in FIG. 2 is for illustrative purposes only, and that the components may be implemented in any manner (e.g., integrated together or separated) without departing from the scope of the invention.

As noted, interpolation system 12 takes the input frame data 16 and upconverts the data to a higher output frame rate based on an upconversion factor 26 “M” that is provided to the motion phase calculation system 14. Thus, M refers to the number of output frames generated for each input frame, i.e., the output frame rate divided by the input frame rate. For instance, if the upconversion factor was set to M=3, the output would include three frames over a time interval T associated with the input frame. (Note that in general, M>1, however, the invention could be implemented with M<1.) As described below in FIGS. 3 and 4, interpolation system 12 can be implemented to generate frame-based or field-based interpolations.

The upconversion factor 26 is translated by motion phase calculation system 14 to temporal locations in a frame period that indicate the moments at which new frames are to be calculated, e.g. n+⅓, n+⅔. The moments at which new frames will be calculated may also depend on factors such as whether the upconversion is frame based or field based, which is discussed below. These moments can be non-uniformly spaced (e.g., n+ 4/9, n+ 7/9) if desired. The temporal locations are then fed to the interpolation system 12 to control the upconversion process.

As shown, the present invention provides for both an integer and non-integer upconversion factor 26. The first example (FIG. 3) described below utilizes frame-based interpolation 22 with an integer upconversion factor 26, the second example (FIG. 4) utilizes field-based interpolation 24 with an integer upconversion factor 26, the third example (FIG. 5) utilizes field-based interpolation 24 with a non-integer upconversion factor 26, the fourth example (FIG. 6) provides cost savings by utilizing the system for reducing motion phase calculations 32, and the fifth example (FIGS. 7-9) utilizes a non-uniform time spacing system 34.

In the first example shown in FIG. 3, frame-based interpolation 22 is utilized with an integer upconversion factor 26. In this case, M output frames are calculated for each input frame. For input frame n, the motion of the color fields of these M output frames is valid for time instances nT, nT+T/M, nT+2T/M, . . . nT+(M−1)T/M. FIG. 3 shows the output data 20 generated by this scheme for M=3, Nₒᵤₜ=3, and a color order of GRB, where Nₒᵤₜ is the number of color fields in each frame and GRB refers to green, red, blue. The Nₒᵤₜ color fields (original or interpolated) in each frame are outputted time-sequentially by a color sequencer (not shown); and the display color field rate is M·Nₒᵤₜ. Note that each original input frame can be used as an output frame, such that only M−1 frames need to be interpolated. Advantageously, the brightest color could be used as a time reference and displayed first.

As can be seen in FIG. 3, the first output frame consisting of Gₒᵤₜ(nT), Rₒᵤₜ(nT+T/9), and Bₒᵤₜ(nT+2T/9), comprises the original input Gᵢₙ(nT), Rᵢₙ(nT), and Bᵢₙ(nT). The second output frame is interpolated for nT+T/3, denoted as boldfaced Gᵢₙ(nT+T/3), Rᵢₙ(nT+T/3), and Bᵢₙ(nT+T/3); and the third output frame is likewise interpolated for nT+2T/3, denoted as boldfaced Gᵢₙ(nT+2T/3), Rᵢₙ(nT+2T/3), and Bᵢₙ(nT+2T/3). Thus, in this embodiment, each color field within the respective output frame is calculated at the same point in time. Accordingly, two of the three color fields are displayed at a time instance for which their motion is invalid; nevertheless, a significant reduction of motion blur is achieved.

In a second example shown in FIG. 4, field-based interpolation 24 is utilized with an integer upconversion factor 26. In this case, each output color field is calculated (i.e., interpolated) with the correct motion phase, which reduces color breakup. FIG. 4 shows the output data 20 resulting from this scheme where M=3, Nₒᵤₜ=3, and the color order is GRB. As can be seen, each color field is positionally adjusted with motion compensation. For instance, the fields in the second output frame, consisting of Gₒᵤₜ(nT+T/3), Rₒᵤₜ(nT+4T/9), and Bₒᵤₜ(nT+5T/9) are interpolated from the input for those same time instances (denoted as boldfaced Gᵢₙ(nT+T/3), Rᵢₙ(nT+4T/9), and Bᵢₙ(nT+5T/9)). The display color field rate is again M·Nₒᵤₜ. Note that only one original color component, Gᵢₙ(nT) can be shown directly at the output, which advantageously may comprise the “brightest” component (e.g., green). To achieve this implementation, M·Nₒᵤₜ−1 fields need to be interpolated.

In the above embodiments, both the display frame rate and the display color field rate are integer multiples of the input frame rate, i.e., M is an integer. By allowing M to be a non-integer number (typically a fraction), more freedom is provided in the choice of the upconversion factor. FIG. 5 depicts an example of the output data 20 for an implementation in which M= 4/3, Nₒᵤₜ=3, the color order is GBR, and motion compensation is applied to each color field using field-based interpolation. Note that while 4/3 is not a significantly high frame rate, it illustrates the principle of this embodiment.

As can be seen in FIG. 5, during the time period from nT to (n+1)T, four color fields are output, G, B, R, and G; during the second time period from (n+1)T to (n+2)T, four color fields B, R, G and B are output, etc. Such an embodiment allows, among other things, the bandwidth of an output display to be fully utilized. For example, if the input rate is 60 Hz and the display bandwidth is 140 Hz, an upconversion factor of 7/3 can be selected to maximize the available output bandwidth. Note that when M is a non-integer, there is no longer a single color component that can be used as a time reference as the input color component that can be displayed directly will alternate.

Various approaches may be utilized to reduce the cost of high frame rate motion-compensated color sequencing. The general principle is to motion compensate those components that contribute most to the perceived brightness, and to distribute the interpolated motion phases evenly over the input frame period T.

FIG. 6 depicts the data output 20 for an implementation in which M= 4/3, Nₒᵤₜ=3, the color order is GBR, and a cost reduction is achieved by utilizing a system for reducing motion phase calculations 32. This system 32 is essentially implemented by performing fewer interpolations. When reducing the number of motion phases (i.e., temporal positions) that get calculated, alternating combinations of color components can be displayed at given motion phases. The result is a trade-off between compensating those color components that contribute most to the perceived brightness, and distributing the interpolated motion phases evenly over the input frame period T. As shown in FIG. 6, motion compensation is applied for every second color field. Obviously, the system for reducing motion phase calculations 32 could be extended to achieve further cost savings by applying motion compensation only to every nth color field, where n is any integer.

Finally, a non-uniform time spacing system 34 may be implemented. LCoS displays, such as those found in e.g., the CINEOS™ product line, apply a special form of color sequencing which is called scrolling color. In this technique, the LCoS panel is illuminated by cyclically scrolling stripes of primary colors, e.g., RGB. When the video data that drives the display is properly synchronized with the scrolling color stripes that illuminate it, a color image is obtained when this process is repeated sufficiently fast. The advantage of this scheme, which is illustrated in FIG. 7 for a panel 40 having color order red 42, green 44, blue 46, is that all colors are present on the panel 40 at all times, which is beneficial for the light output of the display.

The motion-compensated frame rate upconversion techniques discussed above are all applicable to scrolling color displays. However, it can be advantageous if the illuminating color stripes have different heights for the various primary colors. This is illustrated by the panel drive scheme in FIG. 8, which shows how the pixel rows on the panel are addressed for each of the primary colors (GRB in this example; M=3). Time period T_{GR} 52 indicates how long green is displayed before the display of red starts, which is an indication for the height of the green color stripe; T_{RB} 54 and T_{BG} 56 have similar interpretations. Note that T_{GR}+T_{RB}+T_{BG}=T/M for this example. In FIG. 7, the red and green stripes are shown with equal height, i.e., T_{GR}=T_{RB} The blue stripe is however higher than the green and red ones. Thus, as shown in FIG. 8, T_{GR}=T_{RB}<T_{BG}.

The implication is that for motion-compensated upconversion, the primary colors should be calculated for non-uniformly distributed time instances. The output data 20 for such as system is illustrated in FIG. 9 for T_{GR}=T_{RB}=T_{BG}/2=T/12, where again M=3, and the color order is GRB. This scheme can be applied for any M, including M=1. Cost savings can again be achieved by combining selected colors into a single motion phase, as described above with regard to FIG. 6.

It is understood that the embodiments described herein can be implemented with any number of color fields (i.e., primaries), that these primaries can be displayed in any desired order, and that motion estimation and upconversion can be performed in any color space. Thus, although described in RGB color space, the present invention can be implemented to take advantage of the known benefits of applying motion estimation and upconversion in a color space such as YUV.

It is further understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A high frame rate motion compensation color sequencing system (10), comprising:
a system for receiving a first input frame and a second input frame, and for receiving motion vectors (18) associated with the input frames (16); and
an interpolation system (12) that processes the motion vectors and input frames and generates high frame rate motion compensated color sequence data (20) with an output frame rate defined by an upconversion factor (26) having a value greater than one.

2. The system of claim 1, wherein the upconversion factor is an integer.

3. The system of claim 2, wherein the interpolation system includes frame-based interpolation for upconverting frames of color data.

4. The system of claim 1, wherein the interpolation system includes field-based interpolation for upconverting fields of color data.

5. The system of claim 4, wherein the upconversion factor is a non-integer.

6. The system of claim 4, further comprising a system for reducing motion phase calculations that only calculates a motion phase for every nth field of color data.

7. The system of claim 1, further comprising a non-uniform time spacing system.

8. The system of claim 1, wherein the input frames and high frame rate motion compensated color sequence data comprise color data in a format selected from the group consisting of: RBG and YUV.

9. The system of claim 1, wherein a brightest color field in each input frame is used as a time reference such that the field is shown directly in the output without being interpolated.

10. A method for generating high frame rate motion compensated color sequencing data (20), comprising:
receiving a first input frame, a second input frame, and motion vectors (I 8) associated with the input frames (16); and
interpolating the first and second input frames using the motion vectors (I 8) to generate high frame rate motion compensated color sequence data (20) during a defined output time period, wherein a frame rate for the defined output time period is dictated by an upconversion factor (26).

11. The method of claim 10, wherein the upconversion factor is an integer.

12. The method of claim 11, wherein the interpolation step upconverts frames of color data.

13. The method of claim 10, wherein the interpolation step upconverts fields of color data.

14. The method of claim 13, comprising the further step of reducing motion phase calculations by calculating a motion phase only for every nth field of color data.

15. The method of claim 13, wherein the upconversion factor is a non-integer.

16. The method of claim 10, comprising the further step of non-uniformly time spacing color field data.

17. A color sequential display (11) having a system for generating high frame rate motion compensated color sequencing data (20), comprising:
means for calculating motion phases (14) based on an upconversion factor to determine temporal locations for outputted color sequence data;
means for receiving a first input frame, a second input frame, and motion vectors (18) associated with the input frames (16); and
means for positionally interpolating the first and second input frames (12) at the calculated motion phases using the motion vectors.

18. The display of claim 17, wherein the upconversion factor is a non-integer.

19. The display of claim 17, wherein the interpolating means upconverts frames of color data.

20. The display of claim 17, wherein the interpolating means upconverts fields of color data.

21. The display of claim 17, comprising further means for reducing motion phase calculations by calculating a motion phase only for every nth field of color data.

22. The display of claim 17, further comprising means for non-uniformly time spacing color field data.

23. The display of claim 17, wherein a brightest color field in each input frame is used as a time reference such that the field is shown directly in the output without being interpolated.
